(19) United States
(12) Patent Application Publication
(10) Pub. No.: US 2007/0156435 A1
(43) Pub. Date: Jul. 5, 2007

(54) Personalized geographic directory

(76) Inventors: Daniel Rex Greening, Sausalito, CA (US); William John Andrew Fyfe, San Francisco, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/327,243

(22) Filed: Jan. 5, 2006

(51) Int. Cl. G06Q 99/00

(52) U.S. Cl. 705/1

(57) ABSTRACT

A collection of technologies enable users to interact more effectively with items in a geographic directory. The items may include venues such as a restaurant, and actions, such as reserving a table at the restaurant. Items may also include events, productions, or other types of geographic or geotemporal items.

### BACKGROUND OF THE INVENTION

### FIELD OF INVENTION

Situation

Consumers frequently use the Web to find retailers and get maps, typing in their starting location in address form. Modern mobile phones increasingly include internet browsers and geographic positioning devices, which promise to help consumers find and navigate to locations. Through these phones, users can enter an address or, in some cases, use a built-in GPS to position the phone in longitude and latitude. “Find the nearest” applications can then use proximity search methods to find and then display nearby retailers and other venues.

Many brick-and-mortar retailers are becoming “click-and-mortar” retailers, providing web interfaces to purchase movie tickets, find apartments, refill prescriptons, reserve tables at restaurants and reserve books at bookstores. The click-and-mortar services these retailers provide are “location-based services” that could interoperate with find-the-nearest applications.

Voice operators for information services, such as 411 or 511 in the United States, can find venues near an address, and can provide turn-by-turn directions.

Problems

Though mobile phones are convenient to carry, the small screens on internet phones pose great constraints to location services. A “find the nearest” service can typically display only 3 to 8 venues per screen. Imagine trying to find a particular urban cafe or clothing retailer through such a limited interface. Despite such difficulties, consumers buy far more small internet-capable phones than wireless PDAs, indicating that small screen sizes are here to stay.

Limited keyboards on mobile internet phones also introduce difficulties. Small internet phones usually do not have full alphabetic keyboards, so users must type in addresses using cumbersome, unfamiliar mechanisms, such as pressing the “2” key three times for a “C” character. In some cases, the phone suggests possible words corresponding to a sequence of numbers pressed on the phone.

Automated voice interfaces have many of the same difficulties plaguing mobile internet phones. A voice interface must speak instructions and venue lists slowly enough to be understood, but must not take too long or users will abandon the automated interface. Input is usually limited to numbered or spoken choices. Users must often wait for the option they need to be presented, listening to several alternatives before hearing the option they want. These difficulties limit the popularity of automated voice interfaces for location services.

Even with high-resolution screens, users have difficulties with the sheer amount of information presented by find-the-nearest applications. Users rarely select the first venues returned in a find-the-nearest application, because they have additional criteria—such as preferring certain types of restaurants or certain brands of clothing—that cannot be specified through the interface. Mobile users are often attending to multiple activities, such as walking, talking on a cell phone, or driving. Presenting too many options—whether through web, mobile phone or voice interfaces—can distract and annoy. If users are operating equipment, such as driving a car, such distractions can endanger the user and others.

Screen limitations make it difficult to display more information that can help a user make a choice, such as operating hours or the brands repaired at auto service stations. Users must therefore read the venue name, guess its attributes, and finally click on it to get more information. This trial and error method takes time, and may ultimately lead some users to pick an inferior selection or abandon use of “find the nearest” services.

Once a user chooses a venue, existing venue portals restrict what can be done with the venue. Users sometimes want to get a map or directions, sometimes want to call, sometimes just want the address, and sometimes want to take advantage of a store specific interface, such as reserving a table at a restaurant. Today such “actions” must be built into a venue portal, limiting the choices available to a consumer.

Today's venue portal systems require effort for the user to continue making plans in the same area. In the worst case, users must retype an address every time they want to find a venue, even if the new search is in the vicinity of the immediately preceding search. In the best case, users select a “favorite” or “recent” menu item. All of these interactions make the interface more cumbersome for the user.

Alternatives

Some “find the nearest” location services allow users to specify a hierarchical search category. This helps narrow the number of venues more quickly. Users select categories and subcategories, and then click through screens to view nearby venues in a chosen subcategory. Unfortunately, finding the category itself may be difficult.

Some current mobile internet applications allow users to customize the interface. Customization involves a user logging into a web site and setting preferences explicitly. Users must explicitly state they prefer particular venue categories or store names to gain any benefit. But few real users will log into a web site from a personal computer, to customize a phone application. Even those that do may find that fixed categories frequently fail to account for user preferences.

Some carriers involve humans and voice to improve the user interface. For example, InfoNXX offers enhanced directory assistance to mobile carriers. Consumers call 411, and then ask for recommendations. Human operators answer after consulting yellow pages, restaurant guides, or the internet. The primary difficulty with this approach is cost. Normal directory assistance averages US$1.35 per call. It is difficult for human directory assistance shops to ensure uniformly good recommendations, while keeping costs low.

Background: Finding Relevant Items

Some electronic commerce web sites use personalization to recommend items likely to interest a user. Rule-based personalization first consults facts about the user, such as demographic information or purchase history, assigns the user to one or more demographic groups, and then applies pre-set rules, such as recommending golf clubs to those who purchased golf balls. The rules must be manually defined, which limits the accuracy and sophistication of the personalization, and also makes it virtually impossible to adapt quickly to changing behavior patterns.

User facts can include the user's explicit ratings of content, which can allow personalization to be applied for each individual user. Unfortunately, collecting ratings requires explicit user action, which most users will not perform without an obvious payback.

Customization allows users to explicitly define the items they want to see. This differs from personalization in that the system does not attempt to automatically determine what the a user wants, it relies on the user to explicitly specify exactly what the user wants, which can require significant user effort. Customization is very common, because it is easy to implement.

Collaborative filtering attempts to infer what a current user will like by considering the preferences of previous users with similar behavior. This presumes that users who agreed in the past will tend to agree in the future. Collaborative filtering provides fairly good personalization with minimal involvement of the user, but it is only accurate so long as the assumption upon which it is built remains true.

Presenting a categorical hierarchy and allowing users to drill down to any level of the hierarchy is a common practice on many websites and offline directories and indices, such as a “yellow pages” phone book. Because such categorical listings are not personalized, users attempting to find something must know the correct category assigned by the directory. Synonyms and items that could be considered members of multiple categories can cause user confusion, making the search process take longer.

Background: Geographic Search

“Find the nearest” services are becoming commonplace on the web and in mobile navigation systems. A typical “find the nearest” service involves allowing users to specify their postal code via a form to determine the nearest retail outlet or other such venue in or near that zip code region. Some systems use “geocoding” to convert street addresses to longitude/latitude coordinates, mailing proximity search more accurate than postal codes. A problem with proximity search is that there may be many nearby items to choose from, and a user must look through many uninteresting items before finding a desired item.

Sites that offer geographic search often provide only a single action or type of action. Users go to a mapping web site to view a map, get turn-by-turn directions, or view venues on the map. Users go a movie ticket site to purchase movie tickets. Users go to an apartment rental site to find an available apartment. Each time they want to perform a different action, they must re-enter their starting location, either as a postal code, an address, or a set of geographic coordinates. This re-entering of data is cumbersome and error prone.

### Objects and Advantages

An object of the invention is to reduce the interaction required for a user to accomplish the user's goals on mobile internet phones or web sites. The fewer interactions required, the faster the user can complete the goals. Such reduced interaction could include a combination of personalized venue suggestions, personalized action suggestions, personalized category suggestions, action chaining and category-item mixins.

Another object is to present the most relevant and actionable information to the user, even when a display screen may have only a few lines.

Another object is to reduce the amount of time a caller must spend listening to options in automated voice systems.

Another object is to limit the number of options a caller must remember when evaluating options in automated voice systems.

Another object is to provide an abstract notion of “actions” associated with venues, allowing some actions to operate on a subset of venues, and other actions to operate on any venue with a name, while other actions might operate on any venue with a geographic location.

Another object is to make it easy for vendors who manage venues to add venue-specific actions that might be applied, such as reserving a table in a restaurant.

Another object is to provide a built-in system to translate system-wide venue-identifiers to vendor specific venue-identifiers. This reduces difficulties for vendors who use and maintain their own venue identifiers, and do not wish to adopt a portal's venue identifiers.

Another object is to remember a user's past interactions with venues, actions and categories, and suggest appropriate venues, actions and categories when in a new area. This can help reduce a user's confusion, and reduce the need to “drill-down” to get more information on a venue before making a choice.

Another object is to remember which venues, actions and categories the user has frequently seen but infrequently used, characterizing those options as less interesting than items that have never been seen. Such a “measure of disinterest.” can be used to compute the similarity between likeminded users, and help make better suggestions.

Another object is to avoid requiring a user to re-enter an address, and as much as possible to avoid extra interaction by assuming that the user will remain interested in venues, actions and categories in the vicinity of the previous venue. We call this “action chaining.” This will especially help the user to perform multiple activities in one area (shopping, movie, dining, etc.). The system thus encourages consumers to get more clone in one location, saving fuel and time by combining activities into a single trip.

Another object is to incorporate distance in suggestions made to a user. If a venue, action or category is predicted to be very appealing, it should be suggested earlier than closer, but less-appealing items.

Another object is to incorporate distance in computing interest relative to personalization. If a user selects a venue, action or category far from the starting location, the user is indicating a willingness to travel further; hence, the venue, action or category is likely more important than others that don't merit such travel.

Another object is to incorporate distance in understanding a user's particular transportation preferences. Some users drive, some take mass transit, some bike and others walk. Those transportation choices result in differences in the distance a user might travel to accomplish a goal. By, measuring user behavior or getting information from the user, a system can use willingness to travel in computing suggestions.

Another object is to support a supply chain that reaches the consumer through click-and-mortar retailer “actions,” such as refilling a prescription, calling the main number, reserving a book, purchasing event tickets, scheduling a taxi, etc.

Another object is to make it easy for retailers to plug venue-specific operations into a multiplicity of regional portals.

Another object is to provide a mechanism by which an web site can receive commissions for click-and-mortar operations.

Another object is to make it easy for regional portals to incorporate click-and-mortar location services into their web sites.

Another object is to make it easy for a regional portal to register as “location affiliates” and gain commissions when users perform click-and-mortar actions on the portal.

Another object is to make it easy for consumers to find and execute click-and-mortar actions based on current or planned future location.

Another object is to avoid having to ask a user for their preferences, but rather passivels observe their behavior to determine their interests.

Another object is to provide an efficient mechanism to manage lists of actions associated with venues.

### SUMMARY OF THE INVENTION

It is the primary object of this invention to provide a more efficient, personalized interface for a geographic directory. Our primary focus is on mobile phones, as they present a unique user-interface challenge in that the amount of data that can be displayed at a given time may be extremely limited, so there is the potential for a large benefit to be realized by optimizing interactions on these devices. However, the techniques and ideas described should not be construed to be applicable only to mobile phones or similarly limited devices; they can be used to enhance the quality of user interaction through virtually any interface.

The invention is a collection of technologies that enable users to more effectively interact with items in a geographic directory. In one embodiment, items include venues, such as “Chen's Chinese Restaurant,” and actions, such “Reserve a Table.” In some embodiments, events or productions might be considered items. Further types of geographic or geotemporal items might be considered in other embodiments.

One component, the personalizer, observes and records user interactions with items, and then adaptively sorts presented items based on the predicted interests of individual users. This improves the quality of interaction, and allows a user to complete a desired task more effectively. In addition, such a personalizer can be adjusted to optimize certain desired system or business metrics, such as maximizing actions-invoked-per-visit, revenue-per-user (i.e., over several visits), or venue-selections-per-presentation. For example, if the system notices that whenever a particular user requests a list of nearby restaurants they consistently select Chinese restaurants, in the future the personalizer will tend to place Chinese restaurants ahead of others, to maximize any of the system or business metrics previously mentioned.

An embodiment could apply a formula which applies a weight formulaically depending upon distance to an item, such as f(distance)=1/sqrt(distance), modifying a score based solely on predicted user interest without considering distance. A user on foot will likely be more interested in a good restaurant one block away than an excellent restaurant 20 miles away.

An embodiment of the invention also provides a mechanism by which actions may be associated with venues. After a user selects a venue at the action-selection screen, the system can present the set of actions associated with the venue, and then the user can immediately select one, such as “reserve a table”. When finished performing the action, the user can be taken back to an action selection screen to select a different action, such as “visit web site”. This can avoid re-entry of location data.

An embodiment of the invention provides a mechanism for displaying “nearby actions” along with the distance to the nearest venue on which the action can be performed. The user can then select a desired nearby action, such as “purchase movie ticket 0.5 miles”. The system then displays a list of movie theater venues or movie productions. The user selects the venue or production desired, the system changes the “current venue” the venue selected, and the user and system interact to conclude the action. Finally, the system displays an action-selection screen, and the process can continue. Through this “action chaining” mechanism, the user can plan an area visit that includes many tasks, reducing travel time and expense, and reducing the system interactions of re-entering addresses repeatedly.

An embodiment of the invention also includes a mechanism by which third parties can register actions are registered with the system. This allows new behaviors to be added to the system at runtime. Since third parties may have their own venue identifiers, for each action an embodiment can maintain a mapping table that maps the system's venue identifiers to and from each action's venue identifiers. Presuming that each action is assigned an action-id, the mapping table might be composed of these columns: system-venue-id, action-id, and action-venue-id. The system can use the presence of a system venue id in the mapping table to indicate the venues to which the action applies

The system could also store venue data in database tables, such as a venue table storing (system-venue-id, name, address, lat/long, etc.) as well as the necessary data to represent an action (action-id, name, provider, and binary executable code). Thus, when a user requests information about a specific location, the system can consult this mapping, and prepare a list of all known actions that have been added that apply to that location and then display this list to the user. Actions may be such things as “Reserve a Table” or “Get Map of Location” or “Find Venues Near This Location” or essentially any other operation that can take the currently selected venue or geographic position as a parameter.

This support for multiple third party actions allows the system to integrate, or “mash up”, such services seamlessly, making the user interaction more efficient because they do not have to interact with different web sites. For example, if a user wishes to find a nearby restaurant and reserve a table, the addition of a “Reserve a Table” action to an embodiment can allow this interaction to take place completely in the context of a single system, instead of having to first use one system to find a suitable nearby location, and then a second, independent system to perform the actual reservation. By interfacing with the existing infrastructure that allows “Reserve a Table” to be performed, the user interaction is greatly simplified, and the user is able to accomplish more in less time.

An embodiment can combine actions associated with venues, personalize, etc. Adaptively personalizing results to the current user and “mashing up” pluggable actions can create a personalized geographic directory that simplifies user interaction by only presenting those venues and actions interesting to the current user.

An embodiment could include a visual indicator which specifies to the user whether or not personalization is currently being applied. The form of this indicator may vary depending upon the display device that the user is using at the time. For example, it may change the font used to render a link when viewed in a web browser, or add a “(P)” indicator to the title line of a page when viewed on a mobile phone that supports only limited formatting options. The user has the ability to choose whether or not they wish to enable or disable the personalization feature. Turning off personalization can be beneficial if a user seeks a venue or action for an unusual need, or if the user lends the user's mobile phone or browser to a second party and wishes not to reveal personal preferences, or wants the second party to have an unbiased selection.

### DRAWINGS

FIG. 1. Typical mobile internet phone interface

FIG. 2. Location context selection sequence

FIG. 3(a). Unpersonalized find-the-nearest venue

FIG. 3(b). Unpersonalized find-the-nearest venue Wraith subcategories

FIG. 4(a). Personalized find-the-nearest venue

FIG. 4(b). Personalized find-the-nearest action

FIG. 4(c). Personalized categories

FIG. 5. Action chaining effect

FIG. 6. Multiple action implementations

FIG. 7. Database structure

FIG. 8. Major data structures

FIG. 9. Generating nearby actions

FIG. 10. Generating nearby venues for an action

FIG. 11. Generating nearby categories

FIG. 12. Determining the most likely venue for a location

FIG. 13. Retailer use-cases

FIG. 14. Implementation diagram

### DETAILED DESCRIPTION

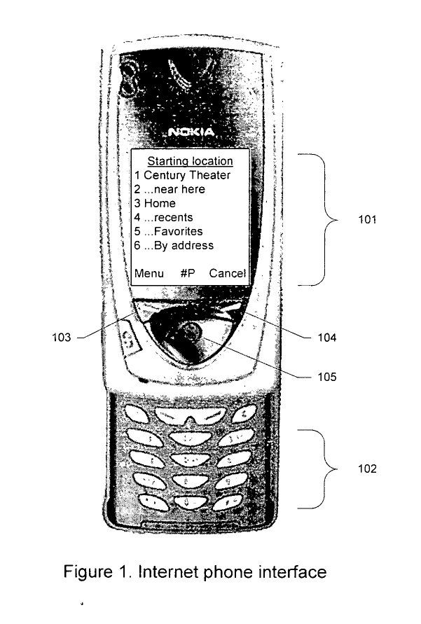

FIG. 1

Mobile internet phones typically have the interface components shown in FIG. 1. A user views the output of a mobile web site on screen 101. The web site may present hyperlinks, such as items 1 through 6, “Menu” and “#P” in FIG. 1. On such a mobile phone, the user may press keys on keypad 102 to activate hyperlinks, for example pressing “1” would activate the hyperlink associated with “1 Century Theater”, and pressing “#” would activate the hyperlink associated with “#P”.Softkeys 103 and 104 are often associated with text displayed on the bottom of the screen. In the example, pressing softkey 103 would activate the hyperlink associated with “Menu” while pressing softkey 104 would activate the hyperlink associated with “Cancel”.An alternative method for activating a hyperlink is using the joystick 105 to select a line, then pushing in the joystick to activate it.

Different mobile phones provide different means for entering text. One means offered by some mobile phones that have only a numeric keypad, such as the device in FIG. 1, requires a user to first activate a text field, then for each character the user must repeatedly press a number to select the character, and either pause or press “#” to move to the next character. For example, to type “hello”, a user might first activate a text field, then type 4 4 # 3 3 # 5 5 5 # 5 5 5 # 6 6 6. This difficulty in entering characters motivates application developers to avoid text input for mobile phone applications.

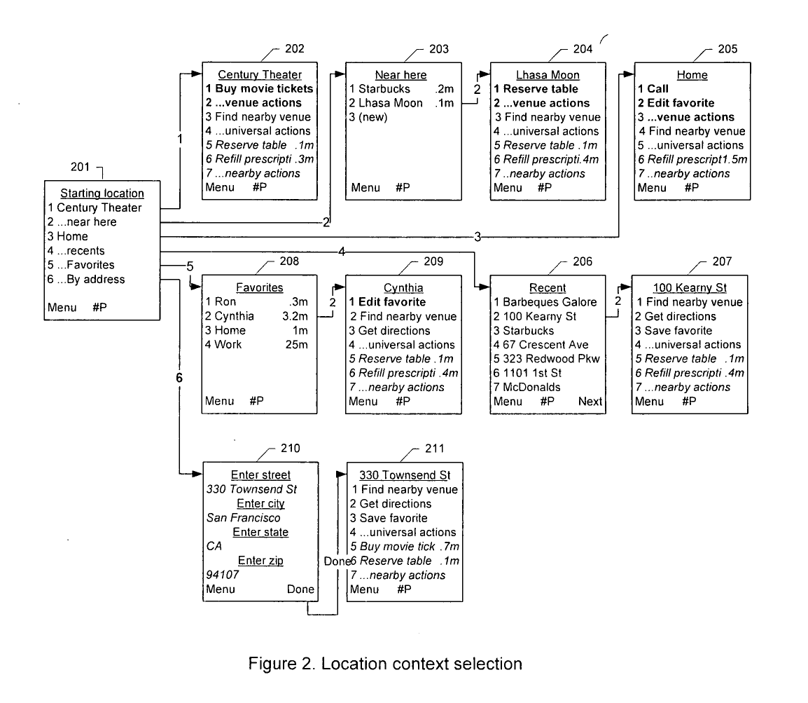

FIG. 2

FIG. 2 shows a sequence of screens provided by an embodiment of the invention. Screen 201 depicts a starting screen asking the user to select a starting location. A means for estimating or guessing the mobile phone's current location has been performed, and in that performance the embodiment determined that the mobile phone was located near “Century Theater”. If the user wishes to start a location service session at the Century Theater, the user presses 1 on the mobile phone keypad, resulting in screen 202. Had the user desired to start from a different location, such as the location of their home, for example, they could have pressed 3, which would result in screen 205.

In most existing positioning technologies, positioning accuracy is not sufficient to identify the venue nearest the mobile phone. For example, in some conditions GPS (geographic positioning system) is only accurate within 20 meters. A user holding a GPS-enabled mobile phone might be at “Lhasa Moon” next door, but because of positioning inaccuracies the computed location is at the “Century Theater” shown in screen 201. To select “Lhasa Moon” as a starting location, the user can press 2 in response to screen 201, then press 2 in response to screen 203.

Note that in one embodiment, the system may apply personalization to help choose a likely starting point, so the choice of “Century Theater” may not be the nearest item from the location returned by the phone's GPS. Instead, the Century Theater may be the embodiment's best prediction of the most interesting starting point nearest the user, using demographic and behavior data about the current user to make the prediction. Such predictions may incorporate accuracy information provided by the positioning device to constrain the prediction to a particular geographic region.

Screen 203 shows two additional options. The user can press 1 to start at Starbucks. The user can press 3 to enter the name and location of a new venue. Instead, the user selects option 2 which results in screen 204. In this embodiment “Century Theater” does not reappear in screen 203, because the user could have selected it in a previous screen. However, other embodiments could include venues that were previously offered.

This embodiment shows a novel mechanism for improving the accuracy of a position which predicts user interests to estimate the starting point. Several “personalization” mechanisms are known in the art for predicting user interest, including collaborative filtering, rule-based expert systems, Bayesian statistics, data mining, user-customization and others. Such mechanisms can be used to predict which nearby venue the user is likely to choose as the starting point. By making an accurate prediction, the system can eliminate one screen and one key press, improving the efficiency of the interface.

In the example shown in FIG. 2, choices for a location near the mobile phone are Century Theater, Starbucks and Lhasa Moon. The system predicted that the user would choose Century Theater, perhaps because the user has previously chosen other theaters, perhaps because the user's behavior was similar to that of other users who chose Century Theater, or perhaps because the user customized the system to indicate a preference for theaters.

In response to a request for a starting point, a user may wish to choose a recently used venue. The most recently-selected venue was “Home”. If the user presses 3 in response to screen 201, the system selects “Home” again. A user may wish to select a recently-selected venue, but not the most recently selected venue. If so the user presses 4 in response to screen 201. In this example, the user then presses 2 in response to screen 206 to select “100 Kearny St”.

A user may wish to save and use venues from a list of personal favorites. In response to screens 207 and 211, the user can press 3 to save the current venue as a favorite.

To choose one of the personal favorites as a starting location, the user can press 5 in response to screen 201 resulting in screen 208. In the example, the user then presses 1 to select “Cynthia” (presumably Cynthia's home) as a starting location, resulting in screen 209.

Notice that all of a user's favorite venues could easily occupy many screens. Favorites shown in screen 208 could be sorted by distance from the user, by distance from the most recently selected location, by predicted likelihood of selection by the user, or alphabetically.

Finally, if the user wishes to specify, a location by address, the user presses 6 in response to screen 201, types the street address, city, state and zip code in screen 210 and presses the “Done” softkey on the phone, resulting in screen 211.

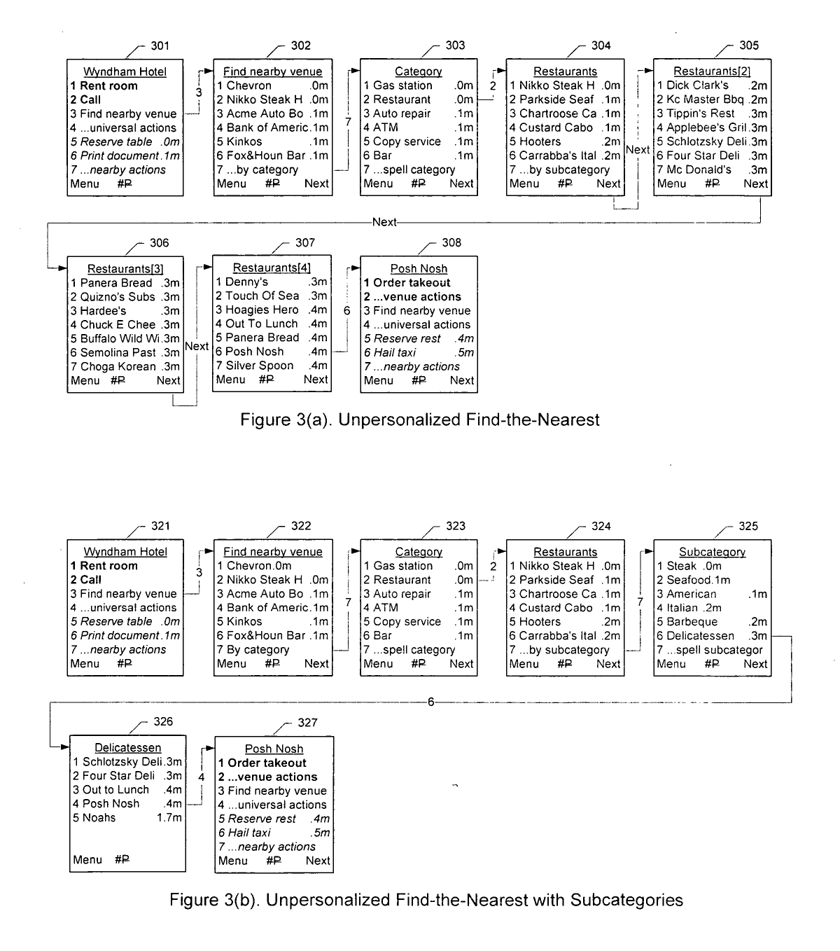

FIG. 3(a)

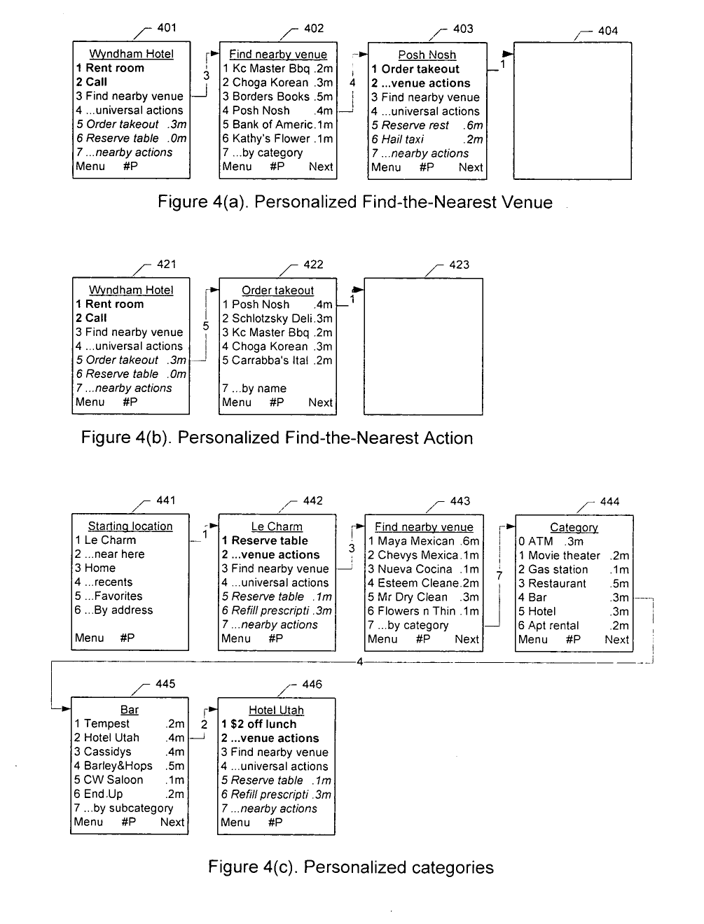

FIG. 3(a), FIG. 3(b), FIG. 4(a), and FIG. 4(b) show example sequences where a user is attempting to find a bagel shop near the Wyndham Hotel.

In FIG. 3(a) the user's mobile phone displays screen 301. The “#P” indicator appearing at the bottom of the screen, with the P having a strikethrough, shows that the data in the screen is not personalized. The user could press “#” to turn personalization on. The user could press 4 to select a “universal action” associated with the “Wyndham Hotel” venue. The user could press 5 to reserve a table at a nearby restaurant. The user could press 6 to print a document at a nearby copy center. However, the user responds to screen 301 by pressing 3 to activate the “find nearby venue” action.

Screen 302 shows a listing of nearby venues. In this case, the venues are listed in order of distance from the starting point without regard to the personal interests of the user. At the bottom of screen 302 is item 7 to choose by category. The user presses 7, resulting in screen 303.

Screen 303 shows a set of venue categories sorted by minimum distance from the starting point. The minimum distance from the starting point is shown on the right of each category. The user could spell the category name in a text field by pressing 7. However, since the user is looking for a bagel shop, which falls in the restaurant category, the user presses 2 at screen 303 to select the restaurant category.

The system then presents screen 304 showing restaurants near the Wyndham Hotel. No apparent bagel shops appear. The user presses the right softkey for “Next” resulting in screen 305. No apparent bagel shops appear. The user presses the right softkey for “Next” resulting in screen 306. No apparent bagel shops appear. The user presses the right softkey for “Next” resulting in screen 307.

Finally in screen 307 a bagel shop called “Posh Nosh” does appear. The user presses 6 to select it, resulting in screen 308.

This sequence required the user to read 8 screens, make 7 decisions, and press 7 keys. The sequence was made easier because the user knew that “Posh Nosh” was a bagel shop. A less-knowledgeable user might have selected incorrect choices, such as “Four Star Deli” or “Schlotzsky Deli”. If the user traveled to those venues, a great deal of time and effort would have been expended. In the best case, because the user was uncertain, the user might have called the venue, consulted a concierge, or asked a friend whether those venues served bagels. In such cases, again the user would have expended time and effort.

FIG. 3(b)

FIG. 3(b) shows a user interaction sequence like that of FIG. 3(a), but with an improvement allowing the user to select a subcategory. Screens 321, 322, 323 and 324 are identical to those in FIG. 3(a). However, in response to screen 324, the user presses 7 to select by subcategory.

Screen 325 then shows restaurant subcategories sorted by minimum distance from the starting point. The minimum distance from the starting point is shown to the right of the subcategory name. The user could spell the subcategory in a text field by pressing 7. However, the user decides that a bagel shop might be listed under “Delicatessen” and presses 6.

Screen 326 then shows the restaurants subcategorized as delicatessens. In screen 326, the bagel shop called “Posh Nosh” appears. The user presses 4 to select it, resulting in screen 327.

This sequence required the user to read 7 screens, make 6 decisions, and press 6 keys. The sequence was slightly shorter than that showin in FIG. 3(a) because the user made use of a bagel-shop encompassing subcategory “Delicatessen.” If the user had instead pressed “Next” at screen 325 to find a “Bagel Shop” subcategory, the resulting effort could have been the same as or worse than the sequence in FIG. 3(a). In short, the use of subcategories reduced the effort and time required to select a venue only marginally in this example.

FIG. 4(a)

FIG. 4(a) shows an example sequence using personalization to help to improve the interface efficiency. Screen 401 refers to the same starting point, Wyndham Hotel, as in screens 301 and 321. However, the last line of the screen contains “#P”, with no strikethrough, indicating that the screen is personalized. The user could turn off personalization by pressing “#”. In addition, different actions are shown, and they are not sorted by distance. The user decides to find a bagel shop and presses 3.

Screen 402 then shows a set of nearby venues, as in screens 302 and 322. However, the venues showmen are not the venues closest to the starting point, and they are not sorted in distance order. Instead, the venues are sorted by the likelihood that the user would select those venues, as predicted by any of several possible techniques, including collaborative filtering, rule-based marketing systems, customization, etc. In the preferred embodiment, such techniques are modified by distance—for example, a user might have a strong preference for sushi, if the user was standing in front of a sushi restaurant, but may be unwilling to travel a long distance to go to a sushi restaurant.

In screen 402, the embodiment computed that the user is more likely to select KC Master Barbeque, Choga Korean, Borders Books, Posh Nosh, Bank of America or Kathy's Flowers than other alternatives that were omitted from screen However, if the embodiment failed to present an item sought by the user in screen 402, the user could press the “Next” softkey.

A user's distance tolerance is likely to vary with the user. Some users are willing to travel long distances, while others are not. The preferred embodiment takes these differences into account in sorting items in presentation to the user in screen 402.

A user's distance tolerance may vary with aspects of the user's current state, such, as whether the user is driving or walking, whether the user is currently in a business or pleasure setting, whether the user is with other people, etc. The preferred embodiment takes these differences into account in sorting items in presentation to the user in screen 402.

In the example, the user is seeking a bagel shop. The user presses 4 to select the Posh Nosh, and then in screen 403 can choose an action. If the user presses 1 in response to screen 403, the system begins a sequence (omitted for simplicity in the figure, and depicted by the empty screen 404) to submit a takeout order on the phone.

In contrast to the sequences shown in FIG. 3(a) and FIG. 3(b), the personalized find-the-nearest example shown in FIG. 4(a) required only 3 screens and 2 key presses to arrive at the Posh Nosh venue screen 403. This dramatic reduction in effort was due to combining personalization with distance in presenting venues to the user.

FIG. 4(b)

FIG. 4(b) shows an example sequence where the user chooses the “action” before the “venue”. In this example, the user is hungry.

Screen 421 presents the starting point, Wyndham Hotel, and also presents two actions that can be performed at the Wyndham Hotel in bold face. If the user presses 1, the preferred embodiment begins a process to rent a room. If the user presses 2, the preferred embodiment calls the hotel. These two boldface actions are called “venue specific” actions because they apply only to certain venues.

The third item in screen 321, “Find nearby venue,” is called a “universal” action because it can be applied to any location where approximate geographic coordinates can be determined. The “Find nearby venue” action uses the location as a starting point, and then finds venues nearby. It is not the only universal action available.

The preferred embodiment estimates the likelihood of the user selecting the available actions, then presents a screen that provides means to access any of the available actions, and to the extent possible presents the user with a configuration that minimizes the expected interaction effort. In short, the user is more likely to choose “Find nearby venue” than other universal actions.

The fourth item, “ . . . universal actions,” indicates that “Find nearby venue” is not the only universal action available. If the user presses 4 in response to screen 421, the preferred embodiment will present a list of universal actions from which the user can choose, ordered by the predicted likelihood the user will choose the action.

The fifth item, “Order takeout” in italics, is called a “nearby action”. Such actions are not provided by the starting location, but instead are provided by venues nearby. In the preferred embodiment, the distance to the closest venue offering the action is shown. Other embodiments may show the expected distance over all the nearby venues offering the action, or may show the distance to the venue the user is predicted most likely to choose.

The sixth item, “Reserve table,” is another “nearby action”.

The user is hungry, and presses 5 to select the “Order takeout” nearby action.

The embodiment then presents screen 422 showing a list of venues that provide the “Order takeout” action. In the preferred embodiment, the venues providing the action are sorted in order of user selection likelihood. In screen 422, for example, although Posh Nosh is more distant than the other selections, because the user is predicted to select Posh Nosh, it appears first. Such user selection likelihood can be computed using collaborative filtering, rule-based systems or user-customization. If collaborative filtering was used in this example, Posh Nosh could have appeared because other users that behaved similarly to the current user have chosen Posh Nosh or venues categorized similarly to Posh Nosh.

When the user presses 1 in screen 422, the “order takeout” action begins in screen 423 (again omitted for simplicity).

FIG. 4(b) demonstrates how choosing an action before choosing a venue can make the user interface more efficient. In FIG. 4(a) where the user chooses the Posh Nosh venue first, the user had to view 3 screens and press 3 keys to activate the “order takeout” action at Posh Nosh. However, in FIG. 4 where the user chooses the “order takeout” action first, the user had to view only 2 screens and press 2 keys to activate the “order takeout” action at Posh Nosh.

FIG. 4(c)

FIG. 4(c) shows an example sequence where the user browses a personalized list of categories. On screen 441, the system has deduced “Le Charm” as the user's starting location. The user can press ‘1’ to view actions associated with this venue, or locate other nearby venues, select the recent venue “Home”, view a list of other recent venues, view a list of favorite venues, or manually specify an address by pressing keys ‘2’ through ‘6’.

The user presses ‘1’ however, resulting in screen 442. This screen displays the options supported by this embodiment of the invention for the “Le Charm” venue. The user can reserve a table or browse additional actions associated with the venue, they can browse universal actions that apply to all venues, or they can search for nearby venues, nearby venues that support a specific action, or retrieve a list of actions supported by nearby venues. In our example, the user is interested simply in finding nearby venues, so they press ‘3’, which corresponds to the “Find nearby venue” link. Of course, the user could have selected “2” on screen 441. However, we show this approach to illustrate that “find nearby venue” is an action, and that it can be used in the context of action-chainimg.

This takes the user to screen 443, which presents a personalized list of venues. Note that “Maya Mexican” is listed first even though it is further away than the other options. This is because the embodiment predicted that the user is most likely to select “Maya Mexican”. In this example, however, the user does not need what they are looking for on this screen. The user might press the “Next” button to browse additional screens of venues, but instead our user presses ‘7’, corresponding to the “ . . . by category” link.

The “ . . . by category” link results in screen 444, which shows a list of nearby categories. The distance to each category is computed as the distance to the nearest venue that falls within that category. Note that the list of categories is not sorted by distance. Instead the system has personalized the list of categories, and sorted the data based off of how likely it thinks the user is to be interested in each category. For example, “ATM” is listed first even though other categories are closer, indicating that the user has a tendency to use the system to locate ATM machines. Our user is not interested in finding an ATM at the moment however, he is looking for a bar, and presses ‘4’, which corresponds to the “Bar” category.

Screen 445 is then displayed, listing nearby bars. This list is also personalized, with bars that the user prefers being listed ahead of closer but less preferred bars. There is also the option to continue searching through finer-grained subcategories by pressing ‘7’, but our user does not follow this path. Instead, the user locates the bar they are interested in, “The Utah”, and presses ‘2’. This results in the final display, screen 446, which displays actions available for the venue “The Utah”.

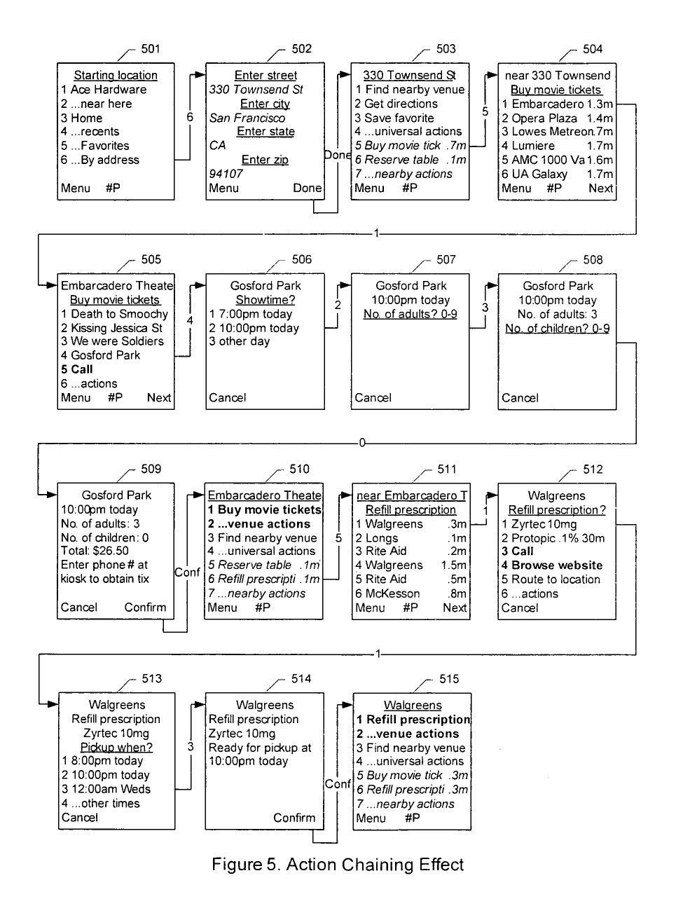

FIG. 5

FIG. 5 shows an “action chaining” example that combines buying movie tickets with refilling a prescription. Because the user is planning a future trip to a new location, the user enters the address in screens 501 and 502. In screen 503, the preferred embodiment uses previous user behavior to anticipate that the user has a high likelihood of purchasing movie tickets, and positions that action first in the list of nearby actions in screen 503. The user presses 5 to initiate movie ticket purchase as seen on screens 504, 505, 506, 507, 508, and 509.

After confirmation of the ticket purchase, the preferred embodiment presents screen 510 with the Embarcadero Theater venue. The user presses 6 to choose the “refill prescription” nearby action.

Screen 511 shows the nearby venues offering a refill prescription action, sorted in order of user selection likelihood. The user presses 1 to choose the closest Walgreens pharmacy to activate the “refill prescription” action as seen on screens 512, 513, and 514.

After confirmation of the prescription refill, the preferred embodiment presents screen 515 with the Walgreens venue.

The term “chaining” is appropriate, because the user links venues, such as screens 503, 510 and 515, by actions.

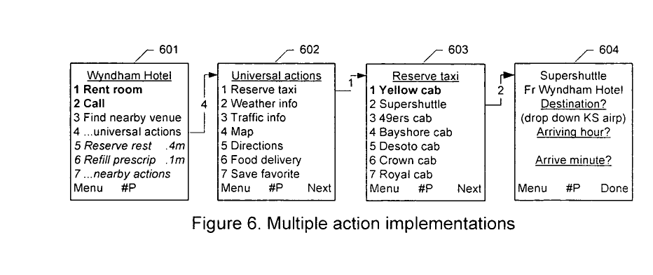

FIG. 6

FIG. 6 shows an example where multiple implementations provide the same action for a venue. The user wants a taxi to pick up the user at the Wyndham Hotel. In screen 601, the user doesn't see a “call taxi” action, so the user presses 4 to find the action in a larger list of “universal actions”. Such universal actions can be applied to any venue or, in some embodiments, to any geographic location.

Screen 602 then presents universal actions for the Wyndham Hotel venue, sorted in order of user selection likelihood. The preferred embodiment omits the “find nearby venue” action from screen 602, because it previously appeared in screen 601. The user presses 1 to select “reserve taxi”.

Screen 603 presents the provider-names for different implementation of “reserve taxi”. The preferred embodiment sorts the provider names in order of user selection likelihood. The user presses 2 to select Supershuttle, which then activates the Supershuttle implementation of “reserve taxi”.

Screen 604 is produced by the Supershuttle implementation of “reserve taxi”

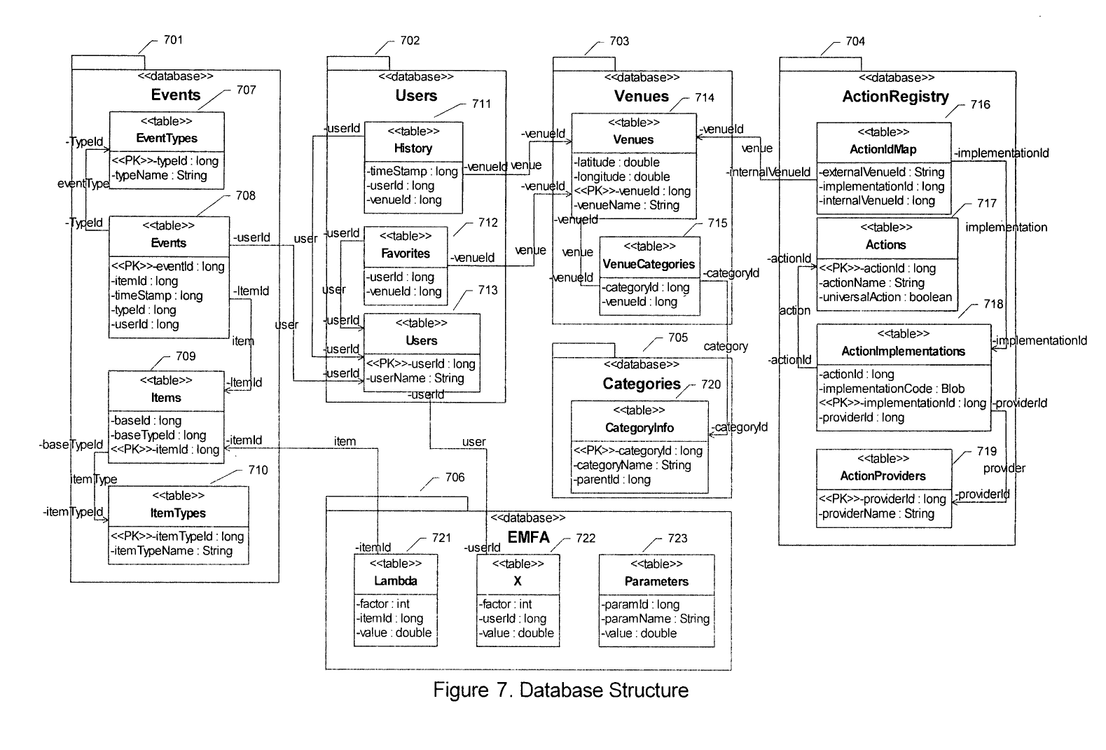

FIG. 7

FIG. 7 shows the database structure supporting a preferred embodiment. The Venues database 703 contains a Venues table 714, which contains a row for every venue known to this preferred embodiment. Every venue is known by a unique venue identifier represented by the venueId column, and must have location information, in this embodiment represented by the latitude and longitude columns. Given the latitude and longitude of a reference location, it is straightforward to calculate a distance from the reference location to any venue in the Venues table. Also stored with each venue is information about the venue; in FIG. 7, only the venue's name is shown, though additional information, such as the address, phone number, web URL or operating hours would be provided in a preferred embodiment. Further, the embodiment allows any venue to be associated with zero or more categories, such a “Restaurant” or “Movie theater”, through the use of the VenueCategories table 715. Each row in this table consists of a venueId and a categoryId, which allows it to implement a many to many relationship between venues and categories.

This embodiment maintains categories in the CategoryInfo table 720 within the Categories database 705. Every category is known by a unique category identifier categoryId, and has a name. Additional information about categories may also be stored, but is not shown here. The categories are hierarchical, so that, for example, “Restaurant:Delicatessen” and “Restaurant:Chinese” may be subcategories of “Restaurant”. To this end, each category has a parent category; for example, “Restaurant:Delicatessen” has “Restaurant” for a parent. Top level categories, like “Restaurant”, have a null parent.

Venue-category associations are maintained by the VenueCategory table 715. The venue identifier for a venue in the Venues table is not required to appear in the venueId column of any row of the VenueCategory table, and if it does not appear then this means thatin which case the venue is not associated with any category. Similarly, the venue identifier may appear in multiple rows of the VenueCategoriesVenueCategory table, if the venue is associated with multiple categories. The category is indicated using a category identifier in the categoryId column.

User data is maintained in the Users database 702. Information about users themselves is maintained in the Users table 713. Each user is known by a unique user identifier userId. Additional information about users may also be stored in this table. In this embodiment, the user's name is stored in the Users table. As shown in FIG. 2 screen 201, the embodiment tracks, for each user, a list of recent venues and a list of favorite venues, which are maintained in the History and Favorites tables 711 and 712 respectively. The History and Favorites tables each include the user and venue identifiers; the History table also stores a timestamp, so that the recent venues list may be displayed with the most recent entry first.

The ActionRegistry database 704 maintains information related to actions. The Actions table 717 stores a unique action identifier actionId for each action, the name of the action as actionName, and a boolean flag universalAction that is true if the action applies universally to all venues, or only to select venues. The distinction between universal actions and venue-specific actions is shown in FIG. 2, screens 202, 204, 205, 207, 209 and 211.

Actions may have multiple implementations, as show in FIG. 6. To this end, the ActionImplementations table 718 stores information about specific implementations. Each implementation is uniquely identified by implementationId, refers to the action that it implements in the actionId column, refers to the provider of the implementation in the providerId column, and contains the computer code for implementation itself in the implementationCode column. The implementationCode value is a blob (binary large object), and could be a JAR file for a JAVA-based implementation, or a DLL file, for a Windows-based implementation.

Information about providers is stored in the ActionProviders table 719. In this embodiment, it includes the unique identifier providerId and the provider's name providerName. Other information, such as the provider's address or billing information could also be stored in this table.

The ActionMap table 716 provides, for each venue-specific implementation, the list of venue identifiers “internalVenueId” to which the implementation applies, and the identifier “externalVenueId” by which the venue is known to the implementation. The embodiment, therefore, allows venues to be identified to implementations in a manner unique to each implementation, and thus implementations need not be aware of the embodiment's own identifiers for venues. Chain retailers and service-aggregators, such as OpenTable or MovieFone, maintain their own store identifiers. The ActionMap table allows their venue-specific action implementations to refer to their own store identifiers.

An alternate embodiment could provide another mapping table that maps internalVenueIds to provider-specific venue identifiers, rather than implementation-specific venue identifiers.

The Events database 701 tracks usage information for personalization. The preferred embodiment tracks two event types: the presentation of an item to a user, and the selection of an item by a user. In this context, an item could refer to a venue, category, action or provider. For example, in FIG. 3, screen 301, the actions “Rent room,” “Call,” “Find nearby venue,” “Reserve table” and “Print document” each generate a presentation event for an action item, and the user pressing 3, “Find nearby venue,” generates a selection event for an action item, adding 6 rows to the Events table 708. The two event types are stored in the EventTypes table 707, which has two columns, one for the event type identifier, and one for the corresponding event type name.

Each row in the Events table contains a unique event identifier eventId, the item identifier itemId, the event type identifier typeId, the user identifier userId, and the time stamp for the event timeStamp. Additional information, such as where specifically an item was presented on the screen could also be stored, but is not shown here.

Everything that can be personalized, whether it happens to be a venue or an action, is given a unique item identifier itemId and stored in the Items table 709. The item corresponding to the item identifier is stored in the table in two parts: an item type baseTypeId, such as venue, and the identifier for the item of that type baseid, such as the venue identifier. The item types are stored in the ItemTypes table 710, which associates with each item type itemTypeId its name itemTypeName. The ItemTypes table has 4 rows in this embodiment, one for each of venues, actions, categories and providers.

In one embodiment, the system performs personalization using “Expectation Maximization Factor Analysis” (EMFA), a personalization technique that involves a two step process: First the system analyzes the behavior of all users offline to construct a “personalization model” and a set of “factors” for each user. Second, the online system uses the model, a user's factors, and the user's behavior history to score items results relative to predicted user interest. We note that EMFA is one of many personalization choices that could be used.

The EMFA database 706 stores the EMFA personalization model. Parameters describing the model are stored in the Parameters table 723. One parameter is the number of factors used in the EMFA model. Another is the status of the model. An EMFA model is made up of two matrices Lambda and X. The matrix Lambda has a number of columns equal to the number of factors, and a number of rows equal to the number of items known to the embodiment. Each value in the matrix Lambda is stored as a row in the Lambda table 721: the three columns are the column index for the matrix value, varying between 1 and the number of factors inclusive, the row index, which is an item identifier, and the value itself. The matrix X has a number of columns equal to the number of users, and a number of rows equal to the number of factors. Like Lambda, each value of the matrix X is stored as a row in the X table 722: the three columns are the column index, a user identifier, the row index, a number between 1 and the number of factors, and the value itself.

To build the EMFA model, the embodiment generates a sparse matrix that has a number of rows equal to the number of users, and a number of columns equal to the number of items. There is an entry in this sparse matrix if the corresponding user has a recorded event with the corresponding item. The value for the entry is the number of invocation events for the item and user divided by the number of presentation events for the item and user. Note that in the embodiment, an invocation event must have a corresponding presentation event, so the number of presentation events for a user and item must be at least as large as the number of invocation events. The ratio between invocation and presentation events, therefore, must be between 0 and 1 inclusive. In this embodiment, the sparse matrix is not stored in the database, but recreated, as required, to build to the model. An alternate embodiment could implement an additional table to store this matrix if recomputing the data as necessary is deemed too inefficient.

To generate an EMFA prediction for a particular user and item, the embodiment selects the row from the Lambda matrix corresponding to the item, and the column from the X matrix corresponding to the user, and computes the inner product. The embodiment optionally adds to this prediction an adjustment based on distance. The notion used by the embodiment is that given two items with the same EMFA prediction, preference would be given to nearer item of the two. The embodiment, therefore, scales the prediction by exp(-distance/alpha). The embodiment uses the scalar alpha to set the unit distance. The value for alpha, in the embodiment is a scalar; however, in other embodiments it could be a function of the user and/or the item.

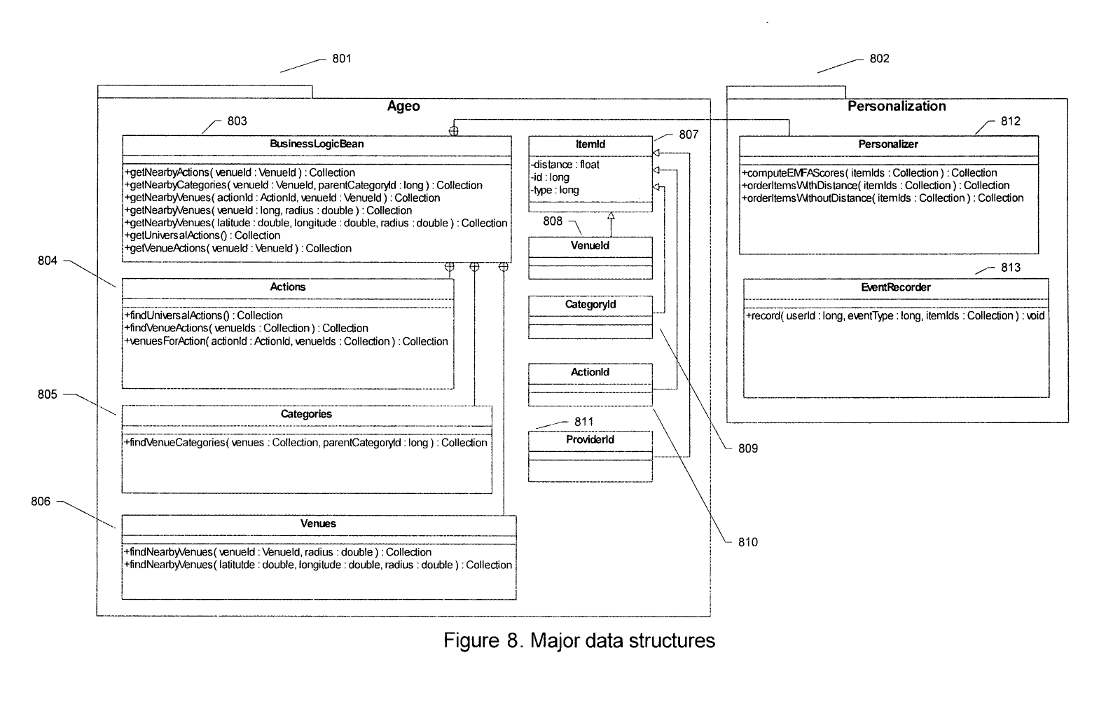

FIG. 8

FIG. 8 shows the major classes used by the embodiment. The embodiment consists of two broad components, the business logic is provided by the “Ageo” component 801, while personalization functions are by the “Personalization” component 802. The BusinessLogicBean 803 provides access to the primary functionality of the embodiment. It generates and returns lists of venues, actions and categories, appropriately ordered. It contains a Venues object 806, which wraps the Venues database, and returns unordered collections of venues, an Actions object 804, which wraps the ActionRegistry database, and returns unordered collections of actions, or determines among a collection of venues those that apply to a given action, and a Categories object 805, which wraps the Categories database and returns unordered collections of categories associated with venues.

To support personalization, there is a generic ItemId object 807, and VenueId 808, ActionId 810, CategoryId 809 and ProviderId 811 all derive from it. An ItemId has a generic identifier and a type, where a VenueId, for example, has a venue identifier and the venue item type. As items may be ordered in a distance aware manner, an ItemId also contains the distance.

The BusinessLogicBean also contains a Personalizer 812 object that it uses to order items. The Personalization component also includes an EventRecorder 813; the web server, once it determines what items are actually shown to the user, or what items have been selected by the user, sends an asynchronous message to an EventRecorder to record the events.

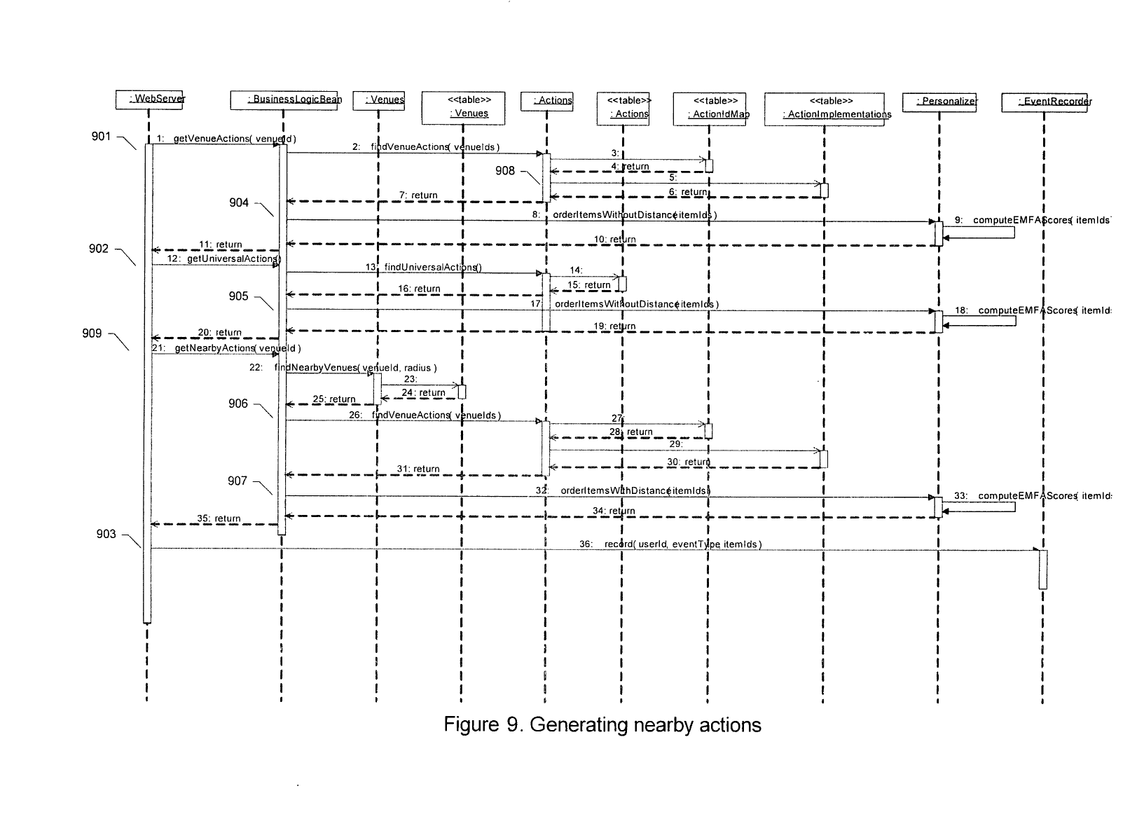

FIG. 9

FIG. 9 shows the steps required to generate the list of actions associated with a particular venue. These actions fall into three categories: those actions that apply to the venue itself, those that apply to any venue, and those that apply to venues nearby. Correspondingly, there are three parts to the sequence diagram.

The first part, made up of sequence events 1 through 11 inclusive (901), shows the steps required to generate the list of actions that apply to the given venue. The single venue, represented as a collection, is used to generate a list of action identifiers. This is done in two steps. First, from the ActionIdMap table, the list of action implementation identifiers that correspond to the venue is generated, and second, from the ActionImplementation table, the list of action identifiers that correspond to the generated implementation identifiers is generated (908). These action identifiers, along with the appropriate type code for actions, become item identifiers, which can be ordered according to the model of the user's preferences (904). As all actions are associated with the same, single venue, they have the same distance, and thus the ordering is done without regard to distance.

The second part, made up of sequence events 12 through 20 inclusive, shows the steps required to generate the list of actions that apply to any venue (902). The actions associated with any venue are generated by extracting those rows from the Action table that have a non-null universal flag. As in the first part, the resulting action identifiers are ordered without regard to distance (905), as again these actions are associated with the same, single venue, and have the same distance.

Finally, the third part, made up of sequence events 21 through 35 inclusive, shows the steps required to generate the list of actions that apply nearby the given venue (909). First a list of venues nearby the given venue is generated. This is done by extracting those venue identifiers from the VenueLocation table that have a location, as defined by the latitude and longitude, near the given venue. During the extraction, the distance to each venue is calculated and retained. The given venue itself is excluded from the generated list of nearby venues. Next the list of venue identifiers is used to generate a list of implementation identifiers, namely those implementation identifiers from the ActionImplementation table that are paired with any venue identifier in the generated list (906).

The embodiment defines the distance to an implementation as the minimum distance to any venue in the list of venues associated with the implementation. As in the first part, this list of implementation identifiers is used to generate a list of action identifiers, using the Action table, though for this part, the embodiment defines the distance to the action as the minimum distance of any implementation from the generated list of implementations. Again these action identifiers, along with the appropriate type for actions, become item identifiers and can be ordered. As there is a distance associated with each of these actions, they can be ordered in a distance-aware manner (907).

The final step for the embodiment is to determine, among the actions returned to it, how to present the actions to the user given, in particular, the constraints of the user's device. As actions are presented to the user, the web server will send presentation events to an EventRecorder so that they may be tracked (903).

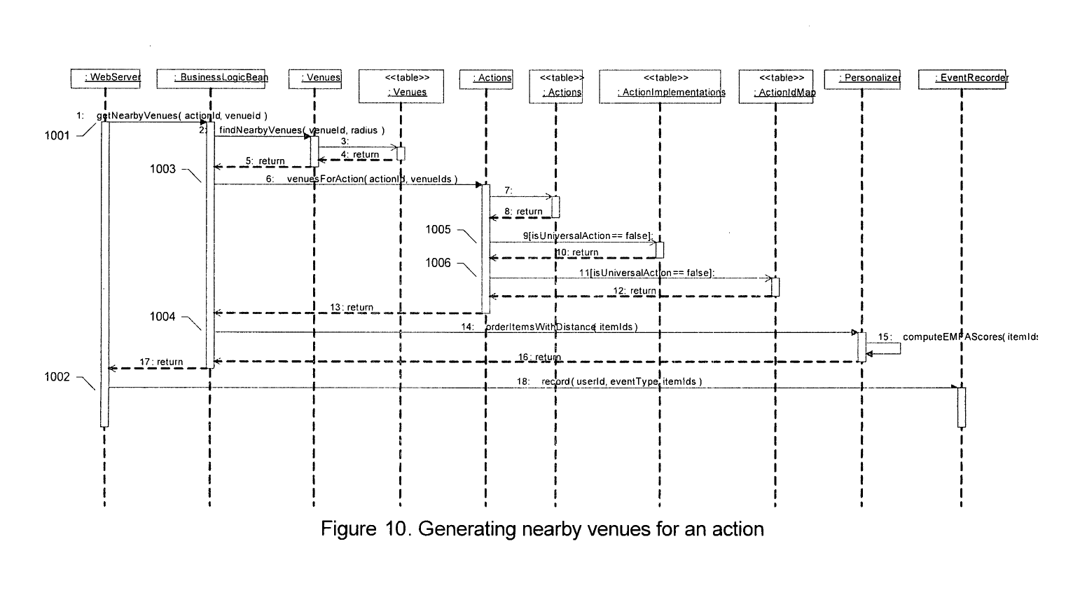

FIG. 10

FIG. 10 shows the steps required to generate the list of nearby venues where an action can be taken. An example of this is show in FIG. 5, screen 504: listed in this screen are venues near “330 Townsend St”, entered in screen 502, to which the “Buy movie tickets” action can be applied, as selected from screen 503. FIG. 6 gives another example, but for a universal action.

First, the list of nearby venues is generated (1001). Again this is done by extracting those venue identifiers from the VenueLocation table that have a location, as defined by the latitude and longitude, near the given venue; also the distance to each venue is calculated and retained (1003). If the action is universal, as it is in the example of FIG. 6, the action applies at all the returned venues. If not, as it is in the example of FIG. 5, the venues must be further restricted to those where the action can be applies. This is done in two steps: first, the implementation identifiers that correspond to the given operation identifier are generated from the ActionImplementation table (1005), and then, using the Actionilap table, only those venues in generated list of nearby venues that are paired with one of the generated implementation identifiers are retained (1006). The resulting list of venue identifiers, along with the appropriate type for venues, becomes a list of item identifiers and can be ordered. The distance to each of these venues was previously calculated, and the ordering is done in a distance-aware manner (1004).

The final step for the embodiment is to present the venues to the user, sending an asynchronous message to an EventRecorder as venues are presented to the user (1002).

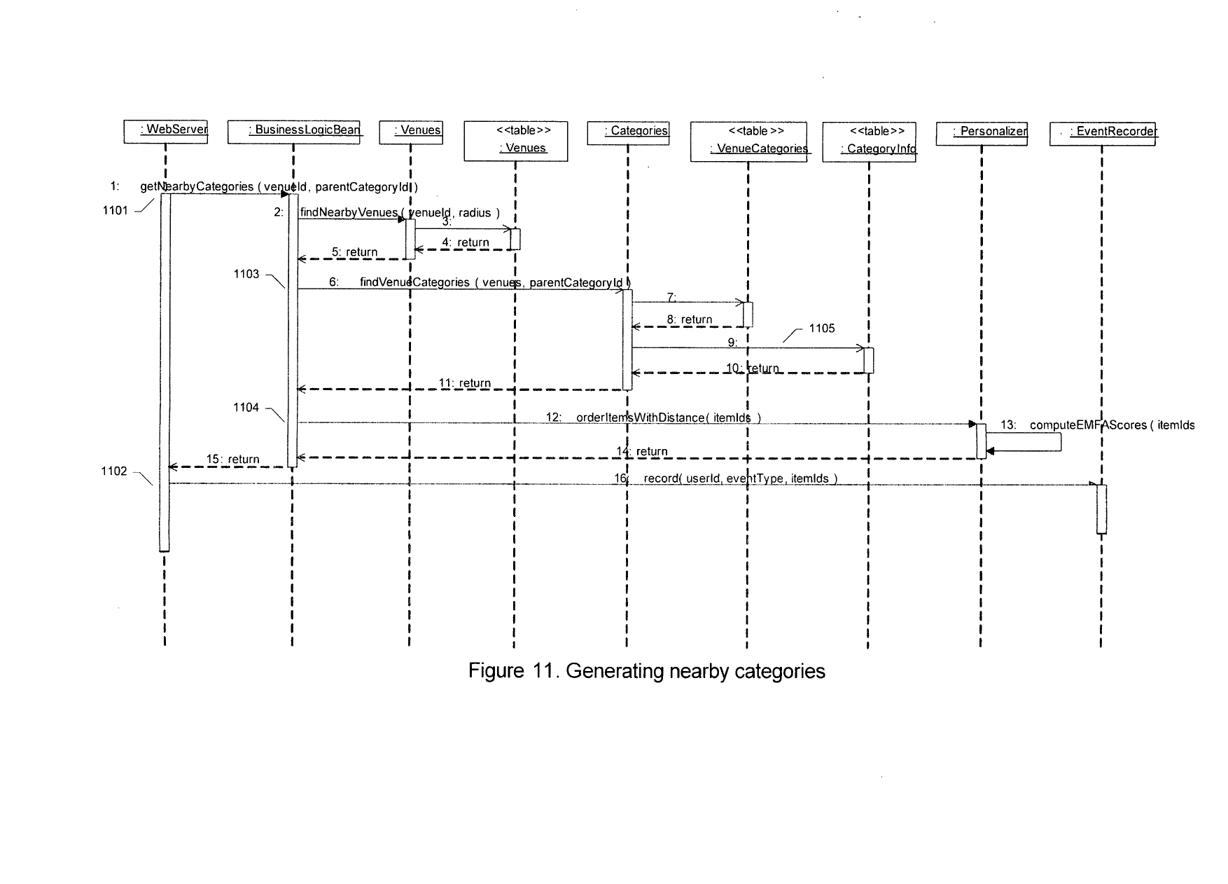

FIG. 11

FIG. 11 shows the steps required to generate a list of venue categories. An example of this is shown in FIG. 3, screens 304, 324 and 325. Note that the embodiment lists only categories for which there is a corresponding venue nearby; it does not simply consider all possible venue categories.

First, the list of nearby venues is generated (1101). Again this is done by extracting those venue identifiers from the VenueLocation table that have a location, as defined by the latitude and longitude, near the given venue; also the distance to each venue is calculated and retained. Next the category identifiers that correspond to any of the venues is generated via the VenueCategory table. The distance to each category is the minimum distance to any venue in that category. Not all categories are necessarily displayed by the embodiment. As shown in FIG. 3 screens 304 and 324 for example, only top level categories are shown while in screen 325, only subcategories of “restaurant” are shown. The category list is restricted based on the parent category id, using the Categories table (1103). For screen 324, the parent category would be null, while for screen 325, the parent category would be “restaurant”. The resulting list of categories, along with the appropriate type for categories, becomes a list of item identifiers and is ordered in a distance aware manner, as each category has a corresponding distance (1104).

The final step for the embodiment is to determine how to present the resulting categories to the user, sending an asynchronous message to an EventRecorder object (1102).

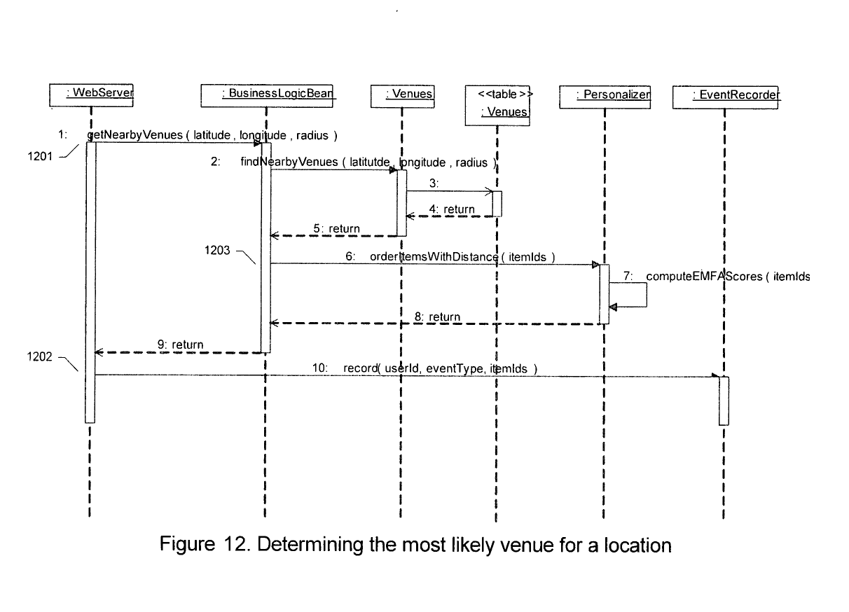

FIG. 12

FIG. 12 shows the steps required to determine the best guess venue for a user, given the user's current position, as shown in FIG. 2, screen 201. Note that the resulting venue is not necessarily exactly at the user's location, given the expected inaccuracies in the user's position. Instead the embodiment finds venues in the immediate vicinity, and picks among those the one it determines is most relevant to the user.

This is simply done in two steps. First a list of nearby venues is found (1201); In this case, the provided radius will be small, so that only venues in the immediate vicinity are returned. The venues are then ordered (1203); the ordering is done in a distance aware manner in this embodiment, while it may be done without regard to distance in other embodiments, on the premise that all the distances are small.

The final step for the embodiment is select a single venue for display, and record the presentation event by sending an asynchronous message to an EventRecorder object (1202).

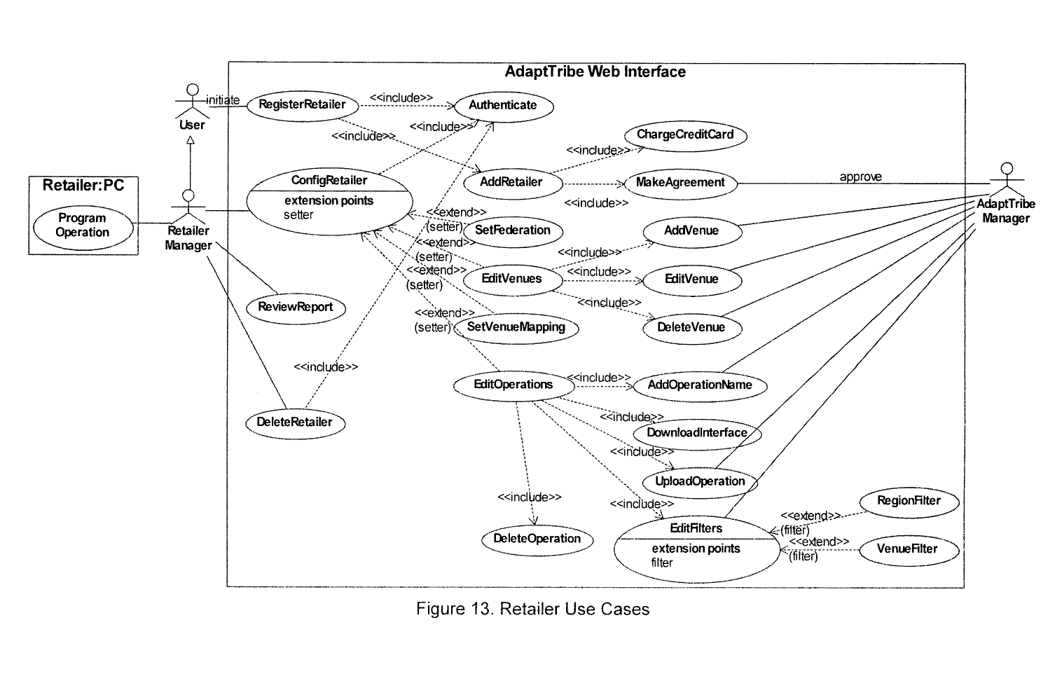

FIG. 13

FIG. 13 shows the use-cases supported by this embodiment of the invention with respect to retailers. Retailers have the ability to register and de-register themselves with the system. When registered, retailers have the ability to synchronize venues and add new venues to an embodiment, specife mappings between their venue id's and those used by the embodiment, and to upload, edit, and delete actions or operations.

The retailers can also specify and modify mappings between their actions and the venues to which they apply.

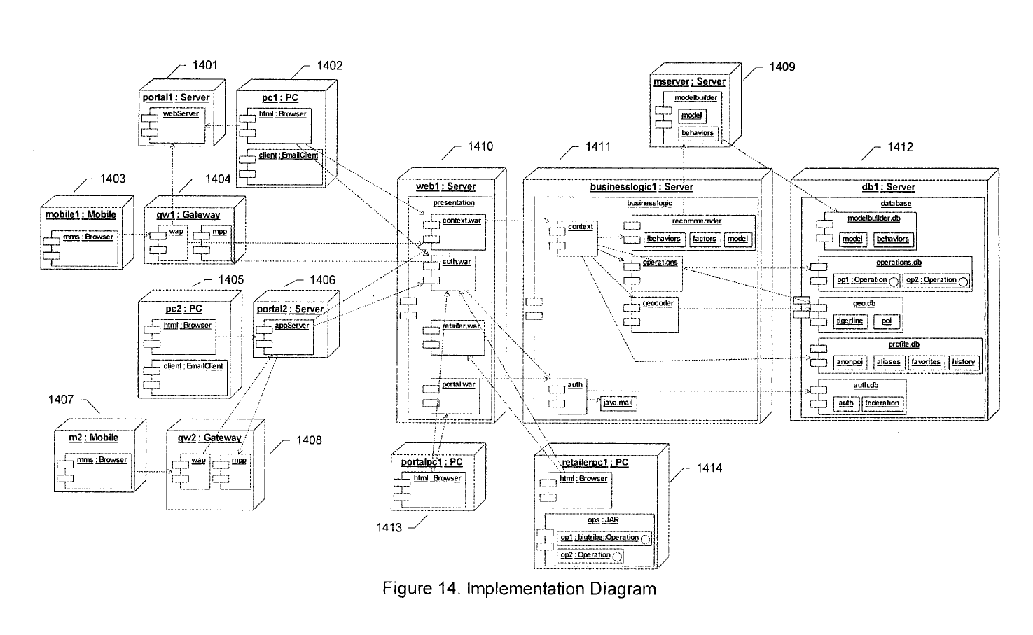

FIG. 14

FIG. 14 shows an implementation diagram for a possible embodiment of the system. This embodiment includes the ability to communicate to a number of different client types, including mobile phones and web browsers, either directly or through portal servers. The described embodiment also implements the web front-end, business logic, model builder, and backing database on separate, independent servers.

We see the web front-end managed by server 1410. This server includes those modules necessary for user authentication and interaction, and the interfaces for communicating with PC's (1402, 1405) and mobile clients (1403, 1407) either directly or through independent portal servers (1401, 1406). In the case of mobile clients, a gateway (1404, 1408) must be used that supports rendering formats that the mobile clients are capable of understanding. It also includes interfaces which provide administrative abilities to both retailers (1414) and portal owner/operators (1413).

The business logic resides on server 1411. It provides an interface that allows the web front-end to communicate with the backing database (1412), and vice-versa. It also interacts with the model builder (1409) as it receives additional data that is useful to the personalization engine, such as information about what items are going to be presented next to the user, or which item the user has selected from a screen of options.

The database server 1412 serves as a host for all the backing data used by this embodiment of the invention. This includes the geographics database, the user database, the action registry database, the personalization database, and the EMFA database generated by the model builder.

The model builder server 1409 builds the EMFA personalization model based on user behaviors.

What is claimed:

1. A method for finding location-associated items comprising:
a. identifying a user,
b. obtaining a first list of items,
c. recording preference data about the user's selection of an item from the first list,
d. determining a reference location,
e. obtaining a second list of location-associated items near the reference location,
f. applying a personalization to predict the interest of the user in items in the second list based on the preference data,
g. sorting items in the second list using a formula based on predicted interest in and distance of items in the second list from the reference location,
whereby the user is presented with a list of items sorted in relative order of predicted personal interest and proximity, such that a nearer item with lesser predicted interest may be listed later than a farther item with more predicted interest.

2. The method of claim 1, wherein said predictive model may be temporarily disabled for said user, further comprises:
a. indicating to said user whether the predictive model is being used or not,
b. responsive to said predictive model being used, providing to said user an option to stop using said predictive model,
c. responsive to said predictive model not being used, providing to said user an option to use said predictive model,
d. responsive to the predictive model not being used, revising said ordering of said list of venues according only to the proximity of each entry in said list of items to said reference location,
whereby said users are given the option to order said list of items based only on proximity or based on both proximity and predicted interest as determined by said predictive model.

3. The method of claim 2, wherein said predictive model is used to personalize a list of categories for said user, further comprises:
a. obtaining a list of nearby items,
b. applying said predictive model to said list to predict the interest of said user in each of said nearby items,
c. sorting the items in said list using said formula based on predicted interest in and distance of the items in said list from said user,
d. obtaining a second list of categories by determining the category of each item in the sorted list of items,
whereby said user is presented with a list of categories sorted in relative order of predicted personal interest and proximity, such that a nearer category with lesser predicted interest may be listed later than a farther category with more predicted interest.

4. The method of claim 1, wherein a retailer may add a new action which is made available to said user, further comprises:
a. said retailer specifies a mapping between their internal item representation and that used by the embodiment of the invention,
b. said retailer specifies meta-data describing their action,
c. said retailer specifies a binary implementation of their action,
d. said mapping and said meta-data and said binary implementation are stored in tables in a database used by an embodiment of the invention,
e. when said user selects an item and there exists in said mapping an entry which corresponds to said item the meta-data for said action is returned as part of a list containing all actions which possess mapping to said item,
whereby said action is presented to said user on a screen which describes all actions which may be performed involving the item which said user has selected.

5. The method of claim 4, wherein said predictive model is used to personalize a list of actions for said user, further comprises:
a. obtaining a list of nearby items,
b. applying said predictive model to said list to predict the interest of said user in each of said nearby items,
c. sorting the items in said list using said formula based on predicted interest in and distance of the items in said list from said user,
d. obtaining a second list of actions by determining which actions are associated with each of the items in the sorted list of times and selecting only the unique instances of each action that appears,
whereby said user is presented with a list of actions sorted in relative order of predicted personal interest and proximity, such that a nearer action with lesser predicted interest may be listed later than a farther action with more predicted interest.
